(19) United States
(12) Patent Application Publication
(10) Pub. No.: US 2008/0129490 A1
(43) Pub. Date: Jun. 5, 2008

(54) Apparatus and Method for Real Time Validation of Cargo Quality for Logistics Applications

(76) Inventors: Jeffrey E. Linville, Gainesville, GA (US); Alan Purvis, Durham (GB); Simon Johnson, Durham (GB)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/869,341

(22) Filed: Oct. 9, 2007

Related U.S. Application Data
(60) Provisional application No. 60/828,466, filed on Oct. 6, 2006.

(51) Int. Cl. G08B 1/08; H04Q 7/00

(52) U.S. Cl. 340/539.13

(57) ABSTRACT

An apparatus and method for real time monitoring of cargo in transit from an origin to a destination. The real time monitoring device comprises a master processor for controlling operation of the device; a global positioning system (GPS) circuit for receiving GPS location data and determining a location of the cargo during transit; a sensor in communication with the processor for sensing a condition of the cargo during transit; a data storage for recording a plurality of data received from the sensor and the GPS circuit, including a date and time, the cargo location, and the sensed condition; a wireless communication modem and antenna in communication with the processor for transmitting, in real time, the date and time, the cargo location and the sensor data to a remote web server; and an onboard power supply for providing power to each element of the device.

### CROSS-REFERENCE TO RELATED APPLICATION

This patent application claims the benefit of a provisional patent application entitled “Apparatus and Method for Real Time Validation of Cargo Quality for Logistics Applications,” filed on Oct. 6, 2006 as U.S. patent application Ser. No. 60/828,466 by the inventors named in this patent application. The specification and drawings of the provisional patent application are specifically incorporated herein by reference.

### BACKGROUND OF THE INVENTION

The present invention relates generally to cargo tracking and delivery and, more specifically, to a method and apparatus for monitoring of cargo quality during shipment to a destination.

Cargo is shipped using a variety of methods with the method of shipment being selected based on factors such as cost, delivery schedule, origin and destination. When the cargo being shipped contains perishable or fragile goods, additional shipping precautions are generally necessary.

There are many situations during the shipping of cargo in which information regarding the precise condition and treatment of cargo, and awareness among shipping personnel that the cargo is being monitored, would aid in the safe arrival of the cargo in a “fit for purpose” condition. However, it is very difficult and frequently very labor intensive to determine the exact location or condition of the goods being shipped while in transit. Cargo tracking usually requires use of various communication means such as phone, facsimile and email between the shipper and cargo carrier to track the location and condition of the goods.

Manufacturers, distributors, retailers and wholesalers of perishable, time-sensitive, and highly valuable goods rely on carrier GPS tracking that is hard-wired into the truck's electrical system to provide information as to the truck's location. The hard-wired GPS units are good for revealing the location of the truck, but do not guarantee that the trailer is attached to the truck. The hard-wired units can also be used as in-cab communications via a keypad, similar to electronic mail and text messages. However, the customer cannot contact the driver in reference to shipment status. The customer would have to contact the carrier via phone or electronic mail to check the location of the truck. The truck driver can unhook the trailer on his own and leave valuable shipments unattended. This could potentially create exposure and risk for temperature variances, pilfering, contamination by others, and abandonment. Knowing the location of the truck is not a guarantee that the trailer is still attached to the truck. One problem with using hard-wired GPS technology is the cost per vehicle to install and maintain the systems. The GPS systems also have to be integrated into the carrier's enterprise resource planning (ERP) software for efficiency and reliability for location data.

There is a need for a system and apparatus that can provide producers of products a real-time, independent method to guarantee the products are being handled in a reasonable manner while in transit. The method would identify the points in the supply chain that continuously create damage, shrinkage, and delays.

Millions of dollars in product inventory are lost each year due to theft of goods while in transit. Creating a deterrence to theft, pilferage, abandonment, rough handling, and mismanagement of shipments could save considerable resources and add to the carrier's profitability.

There is a need for a low cost system and apparatus that can automatically track cargo during shipment and provide the shipper and others with both the location and condition of the goods being shipped at any time during transit.

There is a further need for a device that can be embedded in the shipment of products and that will monitor important environmental conditions and make that data readily available in real time via a web portal.

### SUMMARY OF THE INVENTION

The present invention is directed to the real time tracking and monitoring of the location and condition of items, goods, produce, mail, packages, cartons, containers, etc. (collectively referred to as “cargo”) and any other object that could be dispatched from an originating location to a destination location. The cargo could be delivered through one or more intermediate locations where the cargo could incur a waiting period before continuing on to the destination. The cargo could be supervised while in transit. The route taken between the originating location and destination can be any route, and via any means of transportation, from hand carrying to aircraft, and including sea, river, road, off-road, rail, hovercraft using any vehicle, or transportation using no vehicle at all.

In one aspect of the invention, a device is provided for real time monitoring of cargo in transit from an origin to a destination. The real time monitoring device comprises a master processor for controlling operation of the device; a global positioning system (GPS) circuit for receiving GPS data and determining a location of the cargo during transit; a sensor in communication with the processor for sensing a condition of the cargo during transit; a data storage for recording a plurality of data received from the sensor and the GPS circuit, including a date and time, the location, and the sensed condition; a wireless communication modem and antenna in communication with the processor for transmitting, in real time, the date and time, the location and the sensor data to a remote computer system; and an onboard power supply for providing power to each element of the device. The device can be reusable and all of its components self-contained in a shell made of plastic or other suitable materials. A plastic shell having rounded edges can be formed of a suitable size to accommodate all components. Although, the device can be reusable, it is inexpensive and can be disposed of after use.

In another aspect of the invention, a method is provided for real time monitoring of cargo in transit from an origin to a destination. The method includes attaching a monitoring device to the cargo, the monitoring device including a processor with embedded software to control operation of the device, a global positioning system (GPS) circuit, a sensor, a data storage, and a wireless communication modem and antenna; periodically awakening the device from a sleep mode; establishing a connection to a packet-switched wireless network; receiving GPS location data from the GPS circuit and sensor data from the sensor and determining if the GPS location data is valid; recording the GPS location data and sensor data in the data storage; transmitting a device identifier, valid GPS location data and sensor data in real time to a remote monitoring web server via the wireless network; determining if a communication has occurred between the device and the web server over the packet-switched wireless network during a specified time period; and placing the device in a sleep mode at a reduced power setting if no communication has occurred during the specified time period.

In still another aspect of the invention, a system is provided for real time monitoring of cargo in transit from an origin to a destination. The system includes a web server for receiving real time location and cargo status information over a wireless communication network; a monitoring device attached to the cargo, the device including: a processor for controlling operation of the device; a global positioning system (GPS) circuit for receiving GPS location data and determining a location of the cargo during transit; a sensor in communication with the processor for sensing a condition of the cargo during transit; a data storage for recording a plurality of data received from the sensor and the GPS circuit, including a date and time, the cargo location, and the sensed condition; and a wireless communication modem and antenna in communication with the processor for transmitting, in real time, the date and time, the cargo location and the sensor data to the web server.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates a schematic of the remote monitoring apparatus in accordance with an exemplary embodiment of the present invention.

FIG. 2 illustrates a block diagram representation of the location sensors for the remote monitoring apparatus in an exemplary embodiment.

FIG. 3 illustrates a block diagram representation of the processor configuration for the remote monitoring apparatus in an exemplary embodiment.

FIGS. 4A-4B illustrate a block diagram representation of active and passive sensors for the remote monitoring apparatus in an exemplary embodiment.

FIG. 5 illustrates a block diagram representation of the communications protocol implementation for the remote monitoring apparatus in an exemplary embodiment.

FIG. 6 illustrates a block diagram representation of the General Packet Radio Service (GPRS) protocol implementation for the remote monitoring apparatus in an exemplary embodiment.

FIG. 7 illustrates a block diagram representation of the actuators implementation for the remote monitoring apparatus in an exemplary embodiment.

FIGS. 8A-8B illustrate an external mechanical assembly view of the remote monitoring apparatus and a view of the internal battery module.

FIG. 9 illustrates processing logic for the remote monitoring apparatus in an exemplary embodiment.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

The apparatus (also referred to herein as “device”) of the invention reports to a service provider's web server the precise or recent location of the cargo under surveillance in real time to a time resolution of T1. The reporting period T1 can range from less than a second to many seconds. This enables a shipping company to monitor the cargo's safekeeping during the transit period. The apparatus travels with the shipment and is completely under the control of the owner of the goods shipped. Since the manufacturing cost is low, the device can be deployed easily by companies of varying sizes.

Furthermore, the apparatus collects position and sensor data in real time and relays this information within a time interval T2 to a remote computer or computers (i.e., web servers) specially configured to receive the data transmitted from the surveillance equipment monitoring the cargo. The time interval T2 can range from less than a second to several seconds. This enables shipping personnel to receive regular updates regarding the condition of the cargo within T1+T2 seconds.

In an exemplary embodiment, the device can communicate using a combination of both integrated assisted GPS (A-GPS) chipsets and terrestrial GPRS communications hardware. The terrestrial network can be cellular, or any other data-capable transmission protocol. GPRS is the most widely deployed wireless data service that is available with almost every GSM network. In other embodiments, enhanced GPS chipsets and other communications hardware, such as Enhanced Data Rates for GSM Evolution (EDGE) can be deployed in the device. EDGE is an upgrade to GPRS systems that requires new base stations.

The device enables any adverse condition of the cargo to be quickly identified so that remedial action can be taken. In addition, the device enables identification of cargo that fails to reach its destination, or any intermediate points, or cargo that fails to reach its destination with the appropriate quality. In the monitoring of vehicles transporting precious cargo or passengers, an embodiment of the invention could report safety and health conditions depending on the sensors provided. In this regard, the device can deliver warnings of events that occur in transit to the shipment owner, e.g., when the shipment has not moved for several hours, or when the temperature has reached an unsafe condition.

The device is reprogrammable during transit of the shipment by the owner via a web portal. The default settings for transmission intervals can be reset to allow the shipment owner to closely monitor shipments that are under stress and that require further management.

The device has the capability of remotely determining that it has completed its job and will stop transmitting data every hour, thereby eliminating unnecessary data transmission.

Additionally, using the remote monitoring apparatus, the shipping company could quickly identify cargo that takes a different route to the destination soon after the deviation from the agreed route occurs (within the T1+T2 time delay). This could, with suitable activation, enable the disabling of the transportation vehicle, or alert the shipping company of a vehicle's unauthorized maneuvers.

The remote monitoring apparatus will simultaneously record temperature, shock, humidity, and release of ethylene gas due to decomposition of goods, as well as log time and position. In an exemplary embodiment, the real time remote web site logging only requires a suitable mobile web connection via General Packet Radio Service (GPRS) or Global System for Mobile Communication (GSM) short message service (SMS). The remote monitoring apparatus has some similarity to devices for the remote recording of utility metering for which a custom subscriber identity module (SIM) solution is known. The remote monitoring apparatus is different in the sense that the devices used in exemplary embodiments are mobile, battery-powered units incorporating position sensing.

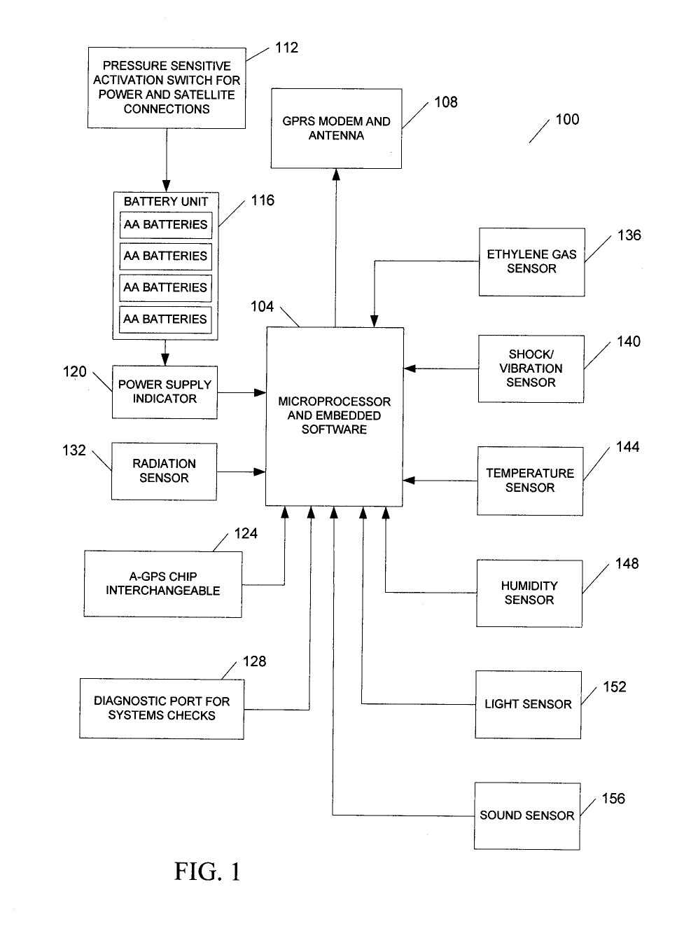

The remote monitoring apparatus can operate as a remote logger for recording position, temperature, shock, humidity and chemicals with a battery-powered unit engineered to last as long as the shipment delivery takes. The remote monitoring apparatus has the ability to keep data safe (i.e., secure) by store and forward mechanisms. FIG. 1 illustrates an overall schematic representation of the device in an exemplary embodiment. The remote monitoring apparatus 100 contains a microprocessor 104 with embedded software, an assisted GPS (A-GPS) chip 124, a GPRS modem and antennas 108, pressure sensitive activation switches 112 for power and satellite connections, a battery unit 116, a power supply indicator 120 and a plurality of sensors. The microprocessor 104 can be a single master processor or a combination of a master processor and a tracker processor. The tracker processor, if separate from the master processor, interfaces with the GPS and GPRS functions. Having a separate master processor facilitates integration with many GPS/GPRS products, but increases software costs.

The plurality of sensors can include, but is not limited to, a radiation sensor 132, an ethylene gas sensor 136, a shock/vibration sensor 140, a temperature sensor 144, a humidity sensor 148, a light sensor 52 and a sound sensor 156. In some scenarios, only a single sensor may be contained in the device. The shock/vibration sensor 140 awakens the device 100 after a certain level. The remote monitoring apparatus when awakened transmits date, time, latitude and longitude which are always monitored. Data that the remote monitoring apparatus 100 transmits via GPRS to a web portal for a customer can include, but is not limited to, latitude, longitude, temperature, humidity, speed, battery life sensor indication, number of satellites read, and radiation sensor, sound sensor and light sensor measurements.

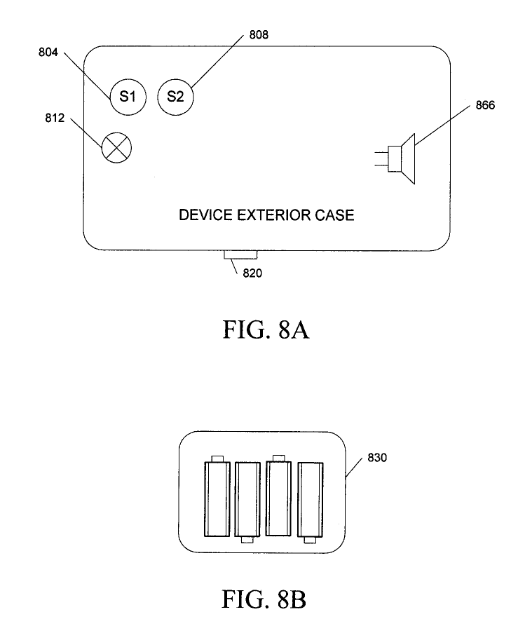

The remote monitoring apparatus 100 of the invention is contained within a robust plastic shell. Batteries are inserted in a battery compartment 116 inside the shell and can be disposable, single use, or rechargeable through an external plug. FIGS. 8A-8B illustrate an external mechanical assembly view of the remote monitoring apparatus and a view of the internal battery module. The plastic shell has no sharp edges or corners and is of a rounded form large enough to accommodate the device electronics, power supply 116, and transducer module 108. The remote monitoring apparatus 100 can be disposable and configured as a single use device. For the reusable remote monitoring devices, the batteries can be recharged and all the data storage settings can be reset to an “as new” configuration.

In an exemplary embodiment of the invention, the remote monitoring apparatus 100 can be fastened to the cargo by means of a strong polyethylene or similar bag which can include shipping paperwork such as dispatch and/or delivery notes. Other methods of fastening could include chains and glue and configurations which are embedded in the cargo construction itself or its packing structures. Attempts to tamper with the package could render the device unusable, with encryption circuits overriding network communications.

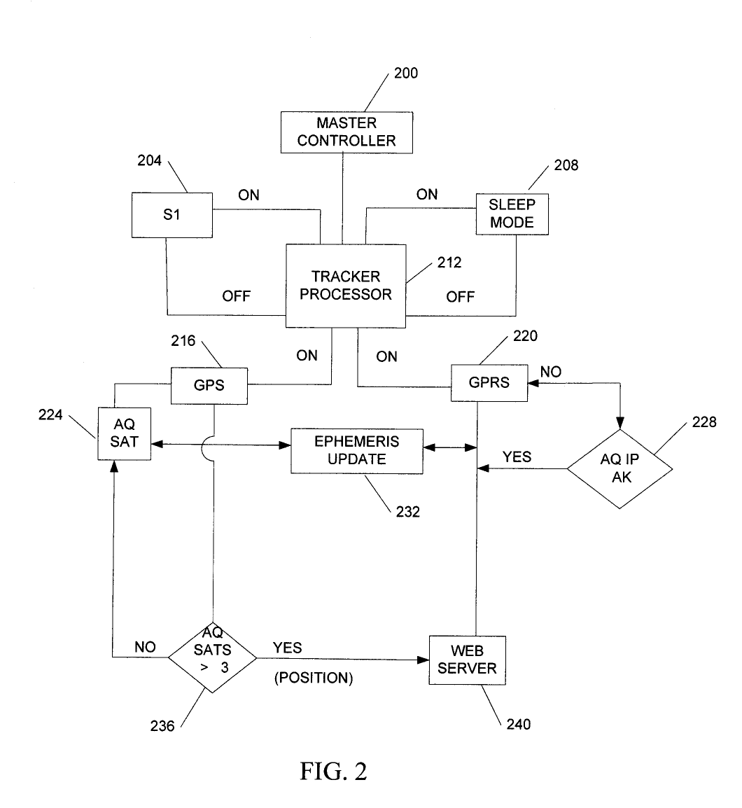

FIG. 2 illustrates a block diagram representation of the location sensors for the remote monitoring apparatus. The tracker processor 212 can either be the master processor or can be controlled by a master processor 200. In the diagram, switch S1 204 and sleep mode operations 208 act directly on the tracker processor 212 but can be overridden by the master processor 200 which may be internal or external to the apparatus. The tracker processor 212 as shown controls only the GPS 216 and GPRS/SMS 220 functionality of the device leaving sensor control to the master processor 200. On acquisition of any satellite 224, the processor 212 can begin to build a local emphemeris 232 to aid the acquisition of other satellites. If during this process the tracker processor 212 establishes an IP connection 228, it can request assistance in building the ephemeris 232 and enable a more rapid acquisition of the remaining satellites. When the number of satellites acquired is greater than 3 (block 236) the position of the apparatus is known and can be relayed to the web server 240. If at any time a satellite is lost due to decreased signal strength, the ephemeris data 232 will provide precise data to assist the recovery of reception from the lost satellite.

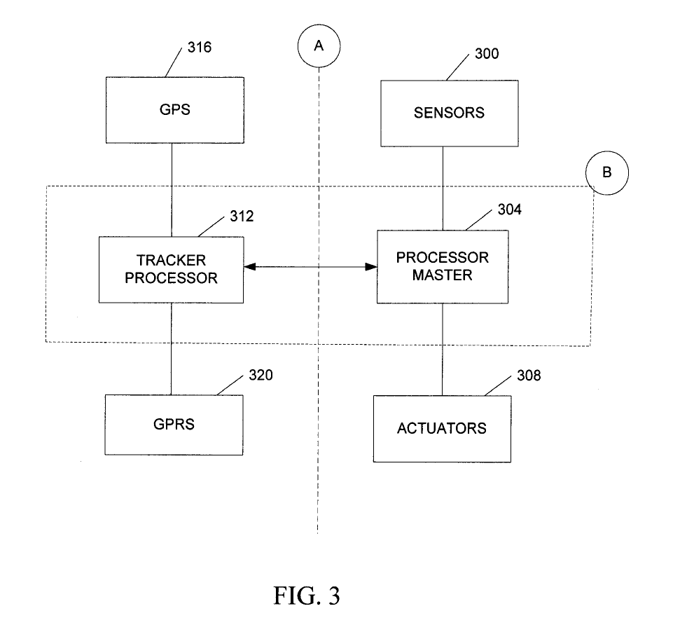

FIG. 3 illustrates a block diagram representation of the processor configuration for the remote monitoring apparatus in an exemplary embodiment. The master processor 304 can communicate with its sensors 300 and actuators 308 and engage with the tracker processor 312 for position sensing and GPRS/SMS connectivity. A sufficiently powerful tracker processor 312 can become the master processor with co-resident master software. The independent master processor 304 facilitates connections with any tracker processor. The vertical dashed line labelled “A” indicates that the master processor 304 can be integrated easily with any tracker processor 312. The dashed box labelled “B” indicates the integration of the tracker processor 312 with master processor 304 and their functions can be combined in a single master processor.

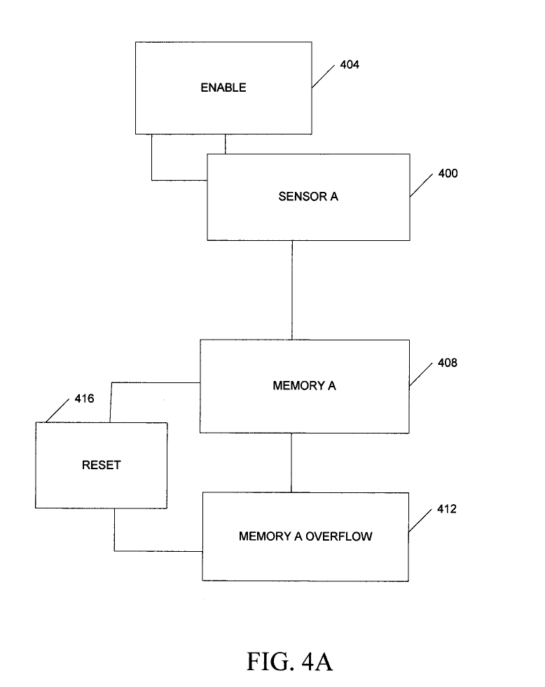

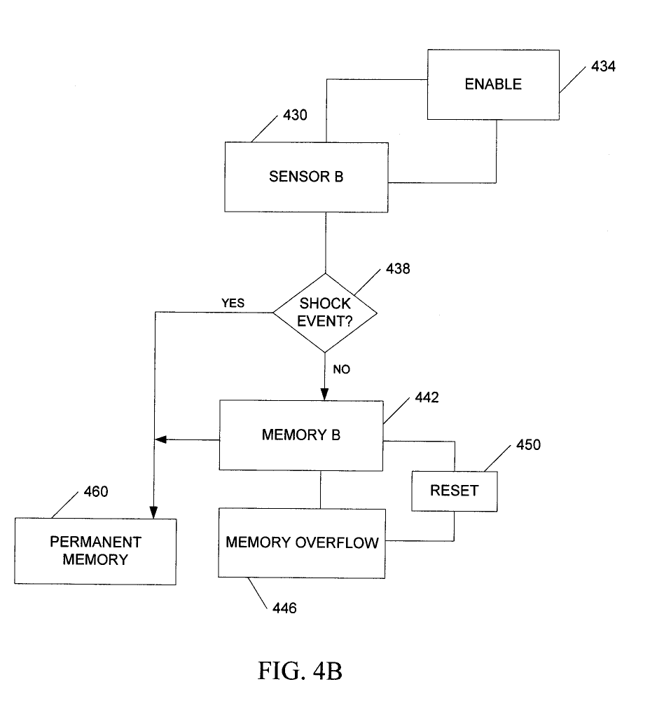

FIGS. 4A-4B illustrate a block diagram representation of active and passive sensors for the remote monitoring apparatus in an exemplary embodiment. For passive sensors such as temperature, as shown in FIG. 4A, the sensor 400 is enabled (block 404) according to the master processor's schedule. Sensor 400 will dump its data to memory 408 with the data tagged with date and location coordinates. If the master processor decides it no longer requires the recorded data, for example, if the data has already been transmitted to the web server, then a reset function 416 is provided. Otherwise the data will wrap around the available memory space (block 412) and reset memory automatically. Thus, only the most recent data is stored in memory 408. For the active sensors, as illustrated in FIG. 4B, where the events just before a shock are encountered (block 438), permanent memory 460 is employed to download before and after images of the sensor 430 data to the web server. Again, if the device memory 442 capacity is exceeded before the data is successfully transferred to the web server, then only the most recent shock images will be stored.

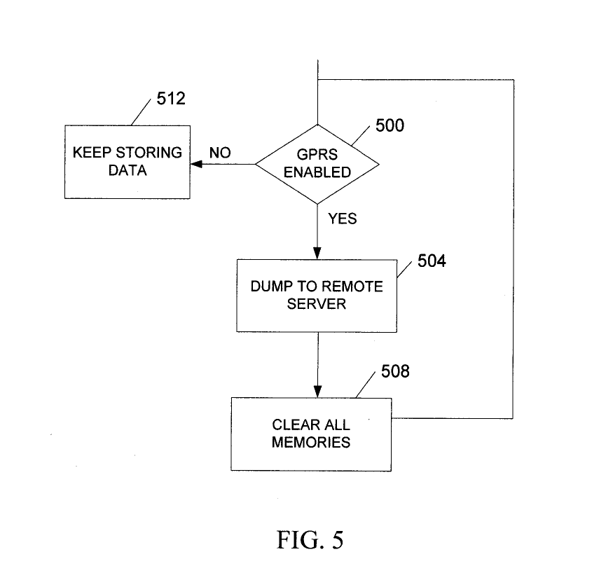

FIG. 5 illustrates a block diagram representation of the communications protocol implementation for the remote monitoring apparatus in an exemplary embodiment. In normal operation, i.e., GPRS enabled (block 500), data is not lost because of the communications protocol employed that transfers recorded data to web storage at the server (block 504) and clears the local memories (508) of the apparatus.

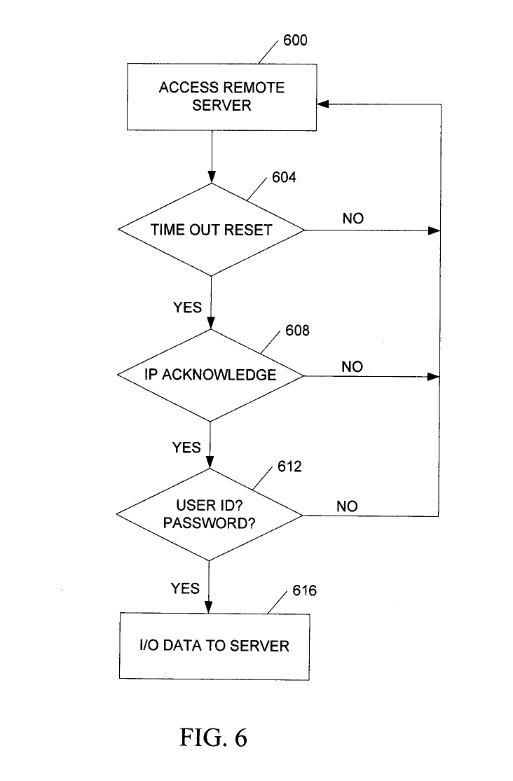

FIG. 6 illustrates a block diagram representation of the General Packet Radio Service (GPRS) protocol implementation for the remote monitoring apparatus in an exemplary embodiment. Connection to a GPRS service involves the verification of the server IP address following the detection of the mobile carrier. The device will repeatedly try to establish a web IP connection with the server as long as the mobile carrier is available. When the web server acknowledges the remote monitoring device (block 608), the device will begin a dialog with the server to verify its identity and provide authorization user identification (User ID) and password data (block 612) before being allowed access to server services (block 616).

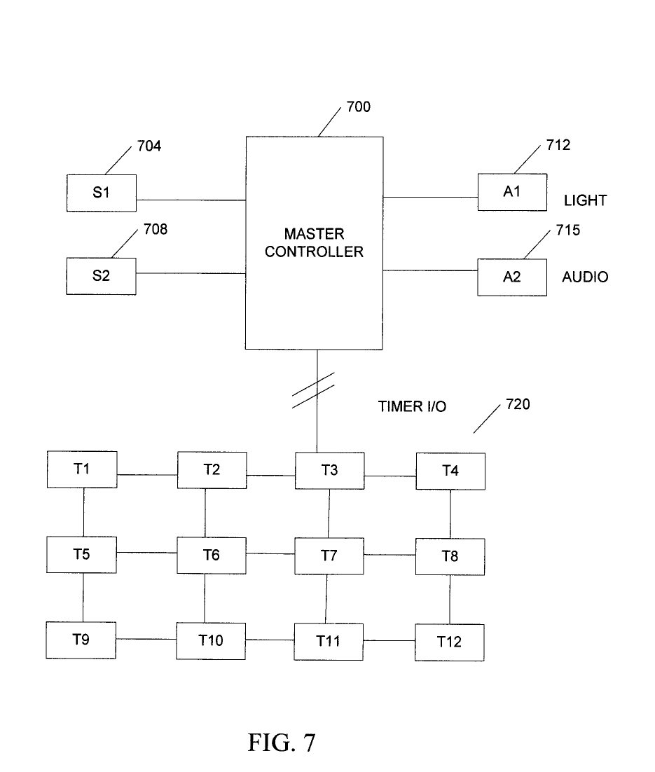

FIG. 7 illustrates a schematic block diagram representation of the implementation of the actuators for the remote monitoring apparatus in an exemplary embodiment. The master controller 700 is aware of all the pre-programmed timing constants 720 set for a given configuration of the apparatus. The number of timing constraints can vary depending upon the configuration of the apparatus. For example, twelve timing constraints are depicted in FIG. 7, although more or fewer timing constraints can be used in other logistics applications. This enables the processor 700 to regulate access to the switches 704, 708 and sensors and light 712 and sound actuators 715 in the domain of the master processor 700.

With reference to FIG. 8A, the remote monitoring apparatus 100 of the present invention can be enabled by the person dispatching the cargo to be tracked by depressing a button S1 804 on its plastic shell when within the plastic bag 830 (FIG. 8B) or fixture for T3 seconds, or long enough to prevent accidental activation. Confirmation of activity is indicated by a flashing light emitting diode (LED) 812 and a beep from speaker 866 lasting for T4 seconds.

For the reusable remote monitoring apparatus, a “find me” alarm will sound when the receiver is trying to locate the unit and is assisted by dialing into a number which activates the unit at its destination. Only calls made when the remote monitoring apparatus is at its destination, or calls from a pre-defined telephone number, will activate the “find me” sensor. The find me alarm is silenced upon retrieval by the activation of a press button S2 808 marked “silence” or similarly. Any press time exceeding T5 seconds will stop the alarm which can only be reactivated by a redial call. The alarm can also be configured as a voice audio system where messages rather than beeps either can be played back or transmitted from the call-up dialer retrieving the device. Pressing S2 for T6 seconds will deactivate the unit.

The sensor board is custom designed with innovative features for the remote monitoring apparatus. The sensor board could be controlled by a master processor which monitors, records, and actuates all remote monitoring apparatus activity, measurements, and communications. The sensed quantities include, but are not limited to, position, height, temperature, humidity, pressure, shock, vibration, and the presence of chemical agents such as carbon monoxide, ethylene, alcohol, etc. The sensed quantities can be measured for a period up to T7 seconds which is dependent on the sampling interval chosen and data word length, after which either the data will be overwritten with new data or further data storage will be inhibited. If an event such as a time trigger, position trigger, shock trigger, or another kind of trigger is recognized by the master processor, the data already recorded is permanently recorded and/or transmitted to the remote web server.

In an exemplary embodiment of the present invention, the sensed quantities can be relayed back to a web server that accumulates data from many devices and gives a spatial—temporal map of the sensed data (e.g., carbon monoxide concentration) from across a city. Random movements of cargo across the city could individually contribute to an overall picture which would be made available to those that had an interest in such overviews. Any anomalous build up of concentrations of a sensed condition could be identified and remedial action could be taken.

In an exemplary embodiment of the remote monitoring apparatus, LEDs are used to show the status of various functions of the remote monitoring apparatus, such as GPRS status, GPS status, sensor activity, and battery status. All these indicators will sleep after 10 minutes of activity following power up. When button S1 804 is pressed, all the visual indicators are reactivated. An audio spectrum transducer 866, either magnetic coil or piezoelectric-based, will give auditory feedback to device operators. An optional display giving information about the state of the device could also be included.

The remote monitoring apparatus has extremely low power consumption, with a battery lifetime of up to 31 days. Longer life variants are possible with larger package sizes. The remote monitoring apparatus achieves this longevity in function by shutting down power consumption whenever it is not actively recording or communicating data. It can be awakened at intervals of T8 seconds and will fall asleep again after T9 seconds if not excited by a broadcast cell message to stay awake and accept the new measurement profile.

The frequency or type of measurements can be pre-programmed to change on access or exit to a given perimeter boundary “geo fence.” The frequency of measurement or type of measurements can be changed by a cellular mobile communication over GPRS or SMS. The remote monitoring apparatus can also self-regulate if its priority is to retain position sensing until arrival at the end of its journey. If at any stage the prediction is that insufficient power remains, then the apparatus will return its current position as a priority until acknowledged by the web server computer.

In an exemplary embodiment, the remote monitoring apparatus is independent of GPS product or GPRS web implementations. The internal master processor can be made to communicate with many of the GPS and GPRS products and integrated product assemblies. The master processor runs a feature known as enhanced GPS that makes use of its data storage and forward capacity to recall and predict position changes. The enhancement can be made by the employment of various sensors such as day/night sensors, cell mobile call cell sensors, inertial sensors and temperature sensors. All this data informs the master processor about the likely geographic location of the remote monitoring apparatus and facilitates the positive fix secured by the GPS unit. In addition a variety of web based calibrations and “sensor fusion” processes are applied. The device employs wherever possible assisted GPS and differential GPS strategies but builds upon these to give a superior integrated performance.

To enable the reuse and/or disposal of the product, the remote monitoring apparatus 100 employs a macrocell SIM implementation which avoids the need to have a publicly accessible call number for every device. Instead each device 100 includes an internal secure web-referenced call number that serves as the identification and billing tag for the units. These identities self destruct after an agreed shelf life or after usage thus enabling massive deployment with limited network congestion.

The remote monitoring apparatus is not confined to one web tracking solution. A custom server will enable the full exploitation and data logging of all remote monitoring apparatus features but the system is downwards compatible with simpler web servers which can only record and display positional data. The processor can be remotely programmed through a flash memory interface to adopt a particular web server's protocol and IP setting. All electronic map data can be interfaced to the web server for presentation to a specific customer of the remote monitoring apparatus service provider.

The web server can relay positional information automatically to remote mobile phones connected by SMS or GPRS, or can be configured to be interrogated on demand. The remote monitoring apparatus 100 can be configured as families and groups and can work in pairs where each pair or triplet simultaneously knows and can display the locations of its siblings/members. In this extension of the invention, the remote monitoring devices become in themselves information display devices by either an embedded display or by audio instructions, the device will report back from the server the location of other remote monitoring devices. Thus a triplet of remote monitoring devices thus enabled will allow three independent agents to have knowledge of each other's and their own positions and local sensor circumstances. Such a configuration will assist teamwork between multiple remote monitoring devices.

A high speed, low latency web interface is available which reports or predicts positions to within T11 seconds of real time where T11 can be as low as 1 second. This enables the real time interception of cargo or the convergence of the seeker with the target in fast dynamic situations. This is enabled by non-lossy compression algorithms and the User Datagram Protocol (UDP) as the transmission protocol where error handling is done on the basis of consistency of data.

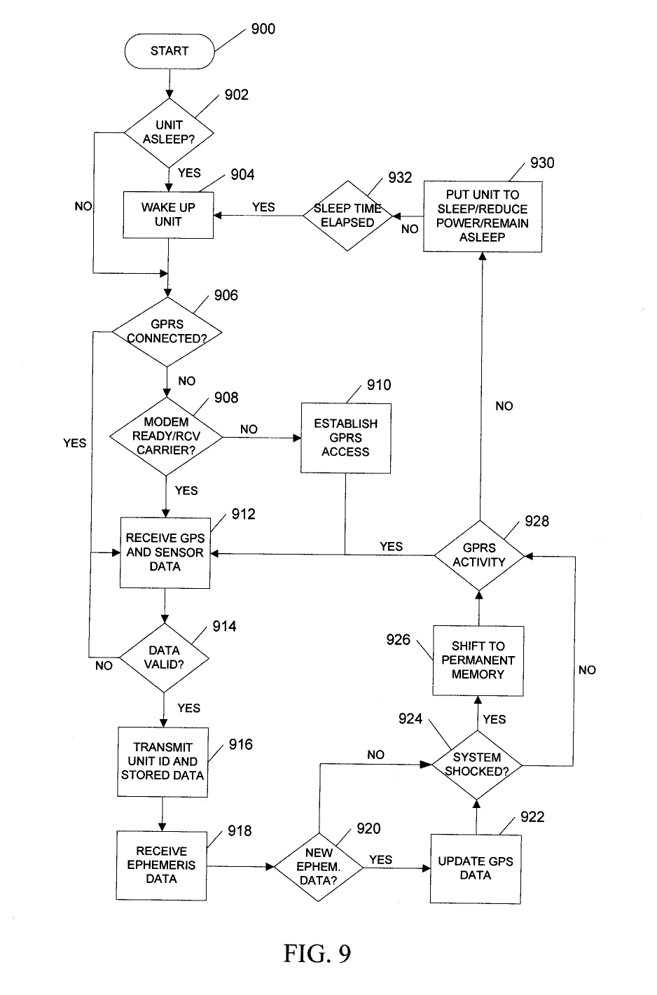

FIG. 9 illustrates the processing logic employed by the embedded software in an exemplary embodiment. It is to be understood that some implementations of the invention may require fewer or more steps. The flowchart should not be interpreted as requiring each step to be performed in the order shown. Furthermore, the example is described in terms of GPRS (which uses the GSM infrastructure to provide end-to-end packet-switched services) and assisted GPS, other suitable methods of wireless communications and enhanced global location determination can be employed.

Processing starts initially in logic block 900 by depressing the “on button” for at least five seconds. In decision block 902, a determination is made if the remote monitoring device is asleep. If the device has been asleep for more than one hour the device is awakened as indicated in logic block 904. The device processor, sensors, GPS unit and GPRS modem are activated. If the device has been asleep for less than an hour, the device remains in sleep mode. If the device is awake, a determination is made in decision block 906 if a GPRS connection exists. If the device does not have a GPRS connection, a determination is made in decision block 908 if the GPRS modem is ready and is receiving a cellular carrier. If the GPRS modem is not receiving a cellular carrier, a GPRS connection is established as indicated in logic block 910.

Once awakened, the device receives GPS and sensor data as indicated in logic block 912. A determination is made in decision block 914 whether or not the GPS and sensor data is valid. If the data is not valid then control is returned to 912 to reacquire the data. If the data is valid, it is stored in device memory. Otherwise, the device continues to receive GPS and sensor data. With GPRS access established, the device identifier and stored data is transmitted to the remote monitoring service provider web site every two minutes as indicated in logic block 916. With GPRS access established, the device receives ephemeris data as indicated in logic block 918. If the ephemeris data represents new data as determined in decision block 920, the GPS data is updated with the ephemeris data as indicated in logic block 922.

A determination is made in decision block 924 as to whether or not the device has been shocked based on data received from shock/vibration sensor 140. Stored data is shifted to permanent memory if the device has been shocked as indicated in logic block 926. The device makes a determination in decision block 928 whether or not there has been any GPRS activity in the last 10 minutes. If there has been activity, the device continues to receive GPS and sensor data (logic block 912). If there has not been any GPRS activity for more than 10 minutes, the remote monitoring device goes into a sleep mode with device power reduced as indicated in logic block 930. The microprocessor and embedded software 104 tracks the elapsed sleep time and determines if the device has been asleep for more than once hour in decision block 932. As long as the elapsed time does not exceed one hour, the device remains in sleep mode. Once the elapsed time exceeds one hour, the device is awakened and processing continues with decision block 906.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed:

1. A device for real time monitoring of cargo in transit from an origin to a destination, comprising:
a processor for controlling operation of the device;
a global positioning system (GPS) circuit for receiving GPS location data and determining a location of the cargo during transit;
a sensor in communication with the processor for sensing a condition of the cargo during transit;
a data storage for recording a plurality of data received from the sensor and the GPS circuit, including a date and time, the cargo location, and the sensed condition;
a wireless communication modem and antenna in communication with the processor for transmitting, in real time, the date and time, the cargo location and the sensor data to a remote computer system via a wireless network; and
an onboard power supply for providing power to each element of the device.

2. The device for real time monitoring of cargo of claim 1 wherein the sensor comprises at least one of a shock/vibration sensor, a temperature sensor, a radiation sensor, a humidity sensor, a light sensor, a sound sensor, and a gas sensor.

3. The device for real time monitoring of cargo of claim 1 wherein the wireless communication modem and antenna provide remote connectivity to a web server using General Packet Radio Services(GPRS) packets or Global System for Mobile (GSM) short message service.

4. The device for real time monitoring of cargo of claim 1 wherein the onboard power supply comprises a rechargeable battery.

5. The device for real time monitoring of cargo of claim 1 wherein the device further comprises a plastic shell.

6. The device for real time monitoring of cargo of claim 5 wherein the device further comprises a fastening means for attaching the device to the cargo.

7. The device for real time monitoring of cargo of claim 1 wherein the processor comprises a master processor for controlling the sensor, the device further comprising a tracker processor under operational control of the master processor for interfacing with the GPS circuit and the wireless interface modem and antenna.

8. The device for real time monitoring of cargo of claim 7 wherein the tracker processor builds a local ephemeris to enable rapid acquisition of location data from a plurality of satellites from which an accurate location of the device can be determined and transmitted to the remote computer system.

9. The device for real time monitoring of cargo of claim 1 further comprising embedded software including a plurality of program instructions executable on the processor to control a functional operation of the device.

10. The device for real time monitoring of cargo of claim 9 wherein the plurality of program instructions control the functional operation of the device, by:
periodically awakening the device from a sleep mode;
determining if the device has established a connectivity to a packet-switched wireless network;
determining if the received GPS location data is valid;
causing a device identifier, valid GPS location data, and sensor data to be transmitted to a remote monitoring web server at a predetermined time interval;
determining if a received ephemeris data is new, and updating the recorded GPS location data if the ephemeris data is new;
determining if a communication has occurred between the device and web server over the packet-switched wireless network during a specified time period; and
placing the device in a sleep mode at a reduced power setting if no communication has occurred during the specified time period.

11. The device for real time monitoring of cargo of claim 9 further comprising a flash memory interface that enables a remote programming of the processor to adapt the device to a remote web server's transmission protocol and Internet Protocol (IP) settings.

12. A method for real time monitoring of cargo in transit from an origin to a destination, comprising:
attaching a monitoring device to the cargo, the monitoring device including a processor with embedded software to control operation of the device, a global positioning system (GPS) circuit, a sensor, a data storage, and a wireless communication modem and antenna;
periodically awakening the device from a sleep mode;
establishing a connection to a packet-switched wireless network;
receiving GPS location data from the GPS circuit and sensor data from the sensor and determining if the GPS location data is valid;
recording the GPS location data and sensor data in the data storage;
transmitting a device identifier, valid GPS location data and sensor data in real time to a remote monitoring web server via the wireless network;
determining if a communication has occurred between the device and the web server over the packet-switched wireless network during a specified time period; and
placing the device in a sleep mode at a reduced power setting if no communication has occurred during the specified time period.

13. The method for real time monitoring of cargo of claim 12 further comprising receiving ephemeris data from a satellite and updating the recorded GPS location data if the ephemeris data is new.

14. The method for real time monitoring of cargo of claim 12 further comprising storing the sensor data in data storage if the device has been shocked during transit.

15. The method for real time monitoring of cargo of claim 12 wherein the connection to the packet switched network is established using a General Packet Radio Services(GPRS) packet or a Global System for Mobile (GSM) short message service.

16. The method for real time monitoring of cargo of claim 12 wherein the sensor data is received from at least one of a shock/vibration sensor, a temperature sensor, a radiation sensor, a humidity sensor, a light sensor, a sound sensor, and a gas sensor.

17. The method for real time monitoring of cargo of claim 12 further comprising building a local ephemeris to enable rapid acquisition of GPS location data from a plurality of satellites from which an accurate location of the device can be determined and transmitted to the remote monitoring web server.

18. The method for real time monitoring of cargo of claim 12 further comprising remotely programming the processor through a flash memory interface to adapt the device to the remote web server's transmission protocol and Internet Protocol (IP) settings.

19. A system for real time monitoring of cargo in transit from an origin to a destination, comprising:
a web server for receiving real time location and cargo status information over a wireless communication network;
a monitoring device attached to the cargo, the device including:
a processor for controlling operation of the device;
a global positioning system (GPS) circuit for receiving GPS location data and determining a location of the cargo during transit;
a sensor in communication with the processor for sensing a condition of the cargo during transit;
a data storage for recording a plurality of data received from the sensor and the GPS circuit, including a date and time, the cargo location, and the sensed condition; and
a wireless communication modem and antenna in communication with the processor for transmitting, in real time, the date and time, the cargo location, and the sensor data to the web server.

20. The system for real time monitoring of cargo of claim 19 wherein the sensor comprises at least one of a shock/vibration sensor, a temperature sensor, a radiation sensor, a humidity sensor, a light sensor, a sound sensor, and a gas sensor.

21. The system for real time monitoring of cargo of claim 19 wherein the wireless communication modem and antenna provide remote connectivity to the web server using General Packet Radio Services(GPRS) packets or Global System for Mobile (GSM) short message service.

22. The system for real time monitoring of cargo of claim 19 wherein the processor comprises a master processor for controlling the sensor, the device further comprising a tracker processor under operational control of the master processor for interfacing with the GPS circuit and the wireless interface modem and antenna.

23. The system for real time monitoring of cargo of claim 22 wherein the tracker processor builds a local ephemeris to enable rapid acquisition of location data from a plurality of satellites from which an accurate location of the device can be determined and transmitted to the remote computer system.

24. The system for real time monitoring of cargo of claim 19 wherein the device further comprises embedded software including a plurality of program instructions executable on the processor to control a functional operation of the device, by:
periodically awakening the device from a sleep mode;
determining if the device has established a connectivity to a packet-switched wireless network;
determining if the received GPS location data is valid;
causing a device identifier, valid GPS location data, and sensor data to be transmitted to a remote monitoring web server at a predetermined time interval;
determining if a received ephemeris data is new, and updating the recorded GPS location data if the ephemeris data is new;
determining if a communication has occurred between the device and web server over the packet-switched wireless network during a specified time period; and
placing the device in a sleep mode at a reduced power setting if no communication has occurred during the specified time period.

25. The system for real time monitoring of cargo of claim 19 wherein the device further comprises a flash memory interface that enables a remote programming of the processor to adapt the device to the web server's transmission protocol and Internet Protocol (IP) settings.
